(19) United States
(12) Patent Application Publication
(10) Pub. No.: US 2010/0110445 A1
(43) Pub. Date: May 6, 2010

(54) SLIT APERTURE FOR DIFFRACTION RANGE FINDING SYSTEM AND METHOD FOR USING THE SLIT APERTURE TO FORM A FOCUSED IMAGE

(75) Inventor: Thomas D. Ditto, Ancramdale, NY (US)

Correspondence Address: SCHMEISER, OLSEN & WATTS, 22 CENTURY HILL DRIVE, SUITE 302, LATHAM, NY, 12110, US

(73) Assignee: 3DEWITT, LLC, Ancramdale, NY (US)

(21) Appl. No.: 12/554,363

(22) Filed: Sep. 4, 2009

Related U.S. Application Data
(60) Provisional application No. 61/094,445, filed on Sep. 5, 2008.

(51) Int. Cl. G01B 11/02

(52) U.S. Cl. 356/499

(57) ABSTRACT

A method and system for forming a focused image on an image plane of a diffraction range finder with a variable pitch diffraction grating. The system includes the variable pitch diffraction grating and a slit through which diffracted light may traverse after having been diffracted by the diffraction grating, wherein the diffracted light is configured to form a focused image on an image plane of a camera after traversing the slit. The method propagates the diffracted through the slit and onto the image plane of the camera, wherein the diffracted light had been diffracted by the variable pitch diffraction grating.

### RELATED APPLICATION

This non-provisional application claims priority to a U.S. Provisional Application Ser. No. 61/094,445, filed Sep. 5, 2008, with the United States Patent and Trademark Office and incorporated herein in its entirety.

### STATEMENT OF GOVERNMENT INTEREST

The invention described herein may be manufactured and used by the Government of the United States of America for governmental purposes without payment of any royalties thereon.

### FIELD OF THE INVENTION

The present invention relates to a means to increase to sensitivity and focus acuity in diffraction range finders by substitution of a slit aperture for a pinhole aperture.

### BACKGROUND OF THE INVENTION

Range finding by diffraction is comprised of the methods, devices and systems used to measure distance through exploitation of a phenomenon observed with diffraction gratings wherein the displacement between diffraction images of the various diffraction orders can be correlated to the distance from the grating to an observed source of energy illuminating the grating. Higher-order diffraction images of a target are reconstructed at a receiver which has a means to focus the radiation onto a transducer that can sense the position of the higher-order diffraction images. As a target is moved toward or away from a grating surface, the relative displacement of a higher-order image from both the zero-order image and other higher-orders images can be measured so as to take target range. The present inventor has demonstrated such a range finder under grants from the National Science Foundation (NSF DMI-9420321). When the diffraction grating is the hologram of a point source and the target is positioned at an angle of grazing incidence relative to the grating, it is possible to form profiles in the microscopic regime. Such an embodiment was developed under a grant from the National Science Foundation (NSF IIP-0724428).

In FIG. 4(a) of U.S. Pat. No. 6,490,028 (hereinafter, '028 Patent), “VARIABLE PITCH GRATING FOR DIFFRACTION RANGE FINDING SYSTEM,” issued to Ditto and Lyon on Dec. 3, 2002, which is reproduced here as FIG. 1, a lens 210 is employed to focus higher-order diffraction images inside camera 200. Exemplary rays are traced from range points 330 along rays 160 through variable pitch diffraction grating 122 after which ray bundles 150 are brought to a focus inside camera 200. The rays cross through a perspective center inside lens 210. This point is a pinhole approximation of a lens. When an actual lens is used, alternative ray paths in bundles 160 and 150 will result in a less than optimal focus at the receiver, most particularly when the grating 124 is a variable pitch grating (also called a “chirped” grating).

The utility of a pinhole at lens 210 of FIG. 1 can be appreciated by an understanding of the fabrication of the variable pitch grating itself. The variable pitch grating used in '028 Patent supra can be fabricated by means of holography. A variable pitch hologram can be created through the intersection of a plane wave originating from a collimator and a spherical wave originating from the pinhole aperture in a spatial filter, a process that is cited in '028 Patent supra by reference to U.S. Pat. No. 3,578,845 issued to Brooks et al. on May 18, 1971, for “Holographic Focusing Diffraction Gratings for Spectroscopes and Method of Making Same.”

The holographic optical train can be a recording process of the type illustrated in FIG. 2. Laser 400 produces a coherent monochromatic collimated beam of light 401 which is divided by beam splitter 411 into beams 402. Spatial filter 412, comprised of a combination lens and pinhole, expands one beam 402 into a spherical wave 403 which is collimated by parabolic mirror 413 and made incident upon holographic recording plate 416 set at angle i relative to incident plane wave 404. The other laser beam 402 divided by beam splitter 411 is also sent by folding minors 414 to spatial filter 415 where it is expanded into a spherical wave 405 to be incident at the surface normal to holographic plate 416. The wavefronts 404 and 405 interfere to cause a pattern that constitutes the variable pitch grating used in a diffraction range finder.

When a pinhole is used in lieu of lens 210 as per the illustrations of '028 Patent supra, the images formed in camera 200 are sharply focused. If the pinhole is of exactly the same diameter as the pinhole that was used to make the spherical wave in the fabrication of the hologram, i.e., the variable pitch grating, the resulting image formed on the image plane of the camera can be optimal in acuity. However, very little light is captured by the camera from the point of origination along the light beam 320 projected from laser 300, because of the small dimensions of the pinhole. Alternatively, a lens 210 can be used in front of the camera 200, but when a lens is used, multiple ray paths through the lens create a focus blur in the final image.

### BRIEF DESCRIPTION OF THE DRAWINGS

FIG. 1 pictorially shows a variable pitch diffraction range finder with a laser as a structured light source and a receiver, in accordance with the prior art.

FIG. 2 illustrates the fabrication of a variable pitch grating by means of holography, in accordance with the prior art.

FIG. 3 pictorially shows a diffraction range finder where a pinhole is used to increase the acuity of the image on the camera image plane, with nine exemplary targets at different ranges and displacements shown with their corresponding rays through the grating to a receiver, in accordance with embodiments of the present invention.

FIG. 4(a) shows a magnified detail from FIG. 3 detailing the exemplary rays passing through a pinhole and on to the image plane, in accordance with embodiments of the present invention.

FIG. 4(b) is a spot diagram of the exemplary target points that would be formed at the image plane using a pinhole aperture, in accordance with embodiments of the present invention.

FIG. 4(c) is the actual image formed at the image plane with a pinhole aperture where some of the targets are missing because of light starvation caused by a pinhole, in accordance with embodiments of the present invention.

FIG. 5 pictorially shows a diffraction range finder where a slit is used to increase the acuity of the image on the camera image plane, with nine exemplary targets at different ranges and displacements shown with their corresponding rays through the grating to a receiver, in accordance with embodiments of the present invention.

FIG. 6(a) shows a magnified detail from FIG. 3 detailing the exemplary rays passing through a slit and on to the image plane, in accordance with embodiments of the present invention.

FIG. 6(b) is a spot diagram of the exemplary target points that would be formed at the image plane using a slit aperture, in accordance with embodiments of the present invention.

FIG. 6(c) is the actual image formed at the image plane with a slit aperture where all of the targets are visible because of the increased efficiency of the slit aperture, in accordance with embodiments of the present invention.

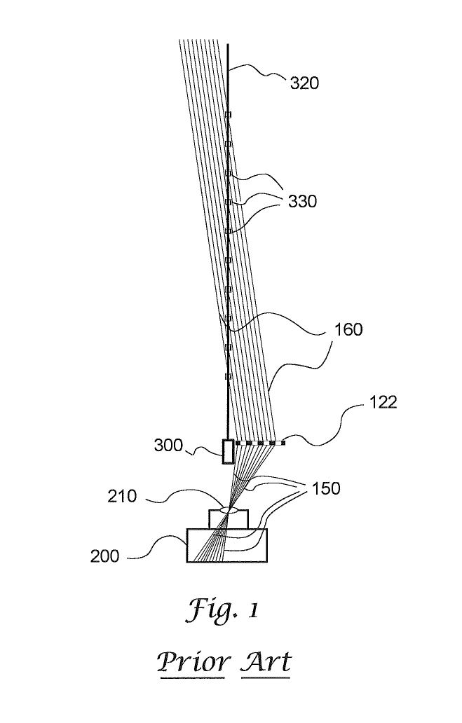

### SUMMARY OF INVENTION

The present invention provides a method for forming a focused image on an image plane of a diffraction range finder with a variable pitch diffraction grating, said method comprising:

propagating diffracted light through a slit and onto an image plane of a camera, said diffracted light having been diffracted by the variable pitch diffraction grating.

The present invention provides a system for forming a focused image on an image plane of a diffraction range finder with a variable pitch diffraction grating, said system comprising:

the variable pitch diffraction grating; and

a slit through which diffracted light may traverse after having been diffracted by the diffraction grating, wherein the diffracted light is configured to form a focused image on an image plane of a camera after traversing the slit.

### DETAILED DESCRIPTION OF THE INVENTION

The present invention uses a slit type aperture in the secondary of a diffraction range finder with a slit spacing equivalent to the diameter of a pinhole aperture used in the prior mathematical models and physical embodiments of diffraction range finders that use variable pitch gratings. The acuity of the image formed with a slit is comparable to the acuity of the image formed with a pinhole but better than ten times more light passes through the slit than passes through the pinhole.

The present invention increases the amount of light passed through the lens at the perspective center inside of a diffraction range finder.

The present invention specifies the shape of the aperture at the perspective center inside of a diffraction range finder.

The present invention generates sharply defined images at the transducer image plane of the camera inside of a diffraction range finder.

The present invention achieves a weight and size savings over range finding systems of equivalent performance based on mirrors and lenses.

The present invention is robust in operation and require little maintenance or care.

The present invention is extensible in application from a small scale instrument for microscopic range finding to large instruments for longer distances of many meters.

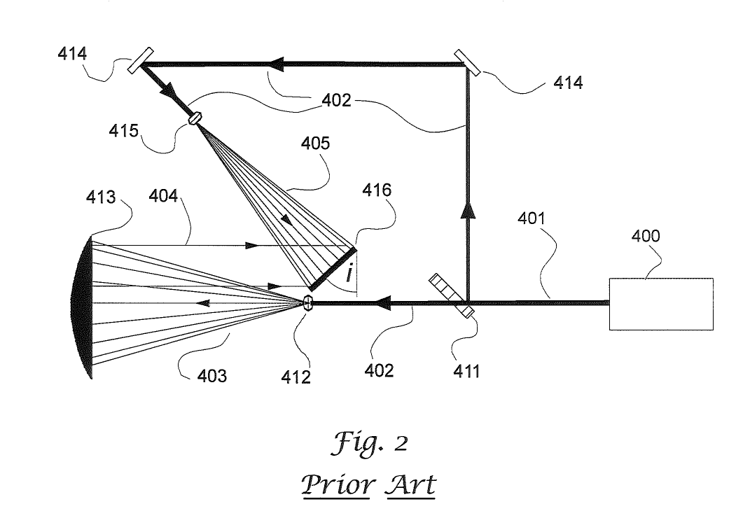

To appreciate the necessity of limiting the spatial dimensions of the pupil in a camera that uses a primary objective chirped grating, image formed without a pinhole iris can be modeled in the optical engineering program, Zemax available from the Zemax Development Corporation of Bellingham, Wash. This software models the behavior of light as it passes through a hologram of the type illustrated by FIG. 2. The Zemax program also has features to model a stop such as a pinhole or a slit. It has analysis features that predict the acuity or focus of an image formed on the final image plane of a camera.

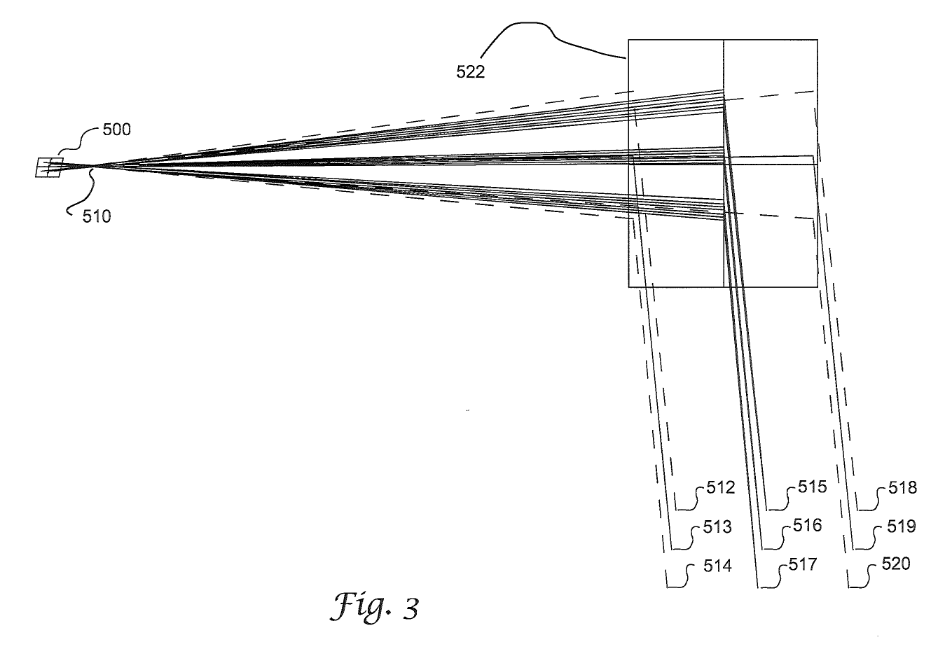

FIG. 3 depicts the Zemax rendering of a diffraction range finder with variable pitch grating 522 as its primary objective. Light originating from exemplary points of different displacements and ranges, 512 to 520, are ray traced through variable pitch grating 522 to pinhole 510 and received at image plane 500. Notably the rays from points 512, 514, 518 and 520 are shown as dashed lines, because their flux levels are so low that they cannot be detected at the image plane.

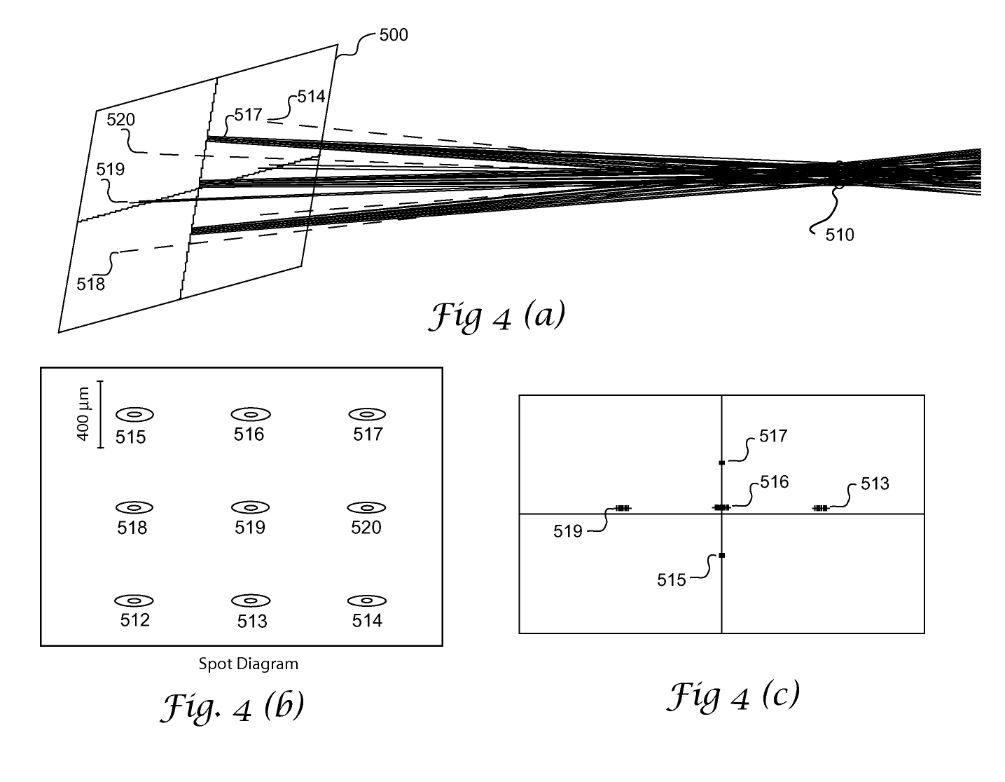

A detail of FIG. 3 appears in FIG. 4(a) showing the ray tracing through pinhole 510 and appearing at the image plane 500. FIG. 4(a) is populated with overlapping rays that obscured labeling, so only targets 514, 517, 518, 519 and 520 are labeled explicitly, but the ray bundles of all targets are traced. The dashed rays of 514, 518, and 520 show that these targets would not be visible because of light starvation caused by the narrow pinhole stop 510 that chokes flux from the variable pitch grating.

If the occluded targets could be imaged, the spot diagram of FIG. 4(b) shows that they would have the same geometric acuity as their sister rays that do successively pass through the pinhole. All nine rays are rendered in the spot diagram. If flux was infinite, all nine rays could be seen, but flux is finite.

The result of light starvation caused by the pinhole aperture is shown in FIG. 4(c). Images of targets 513, 515, 516, 517 and 519 appear at the image plane but targets 512, 514, 518 and 520 do not.

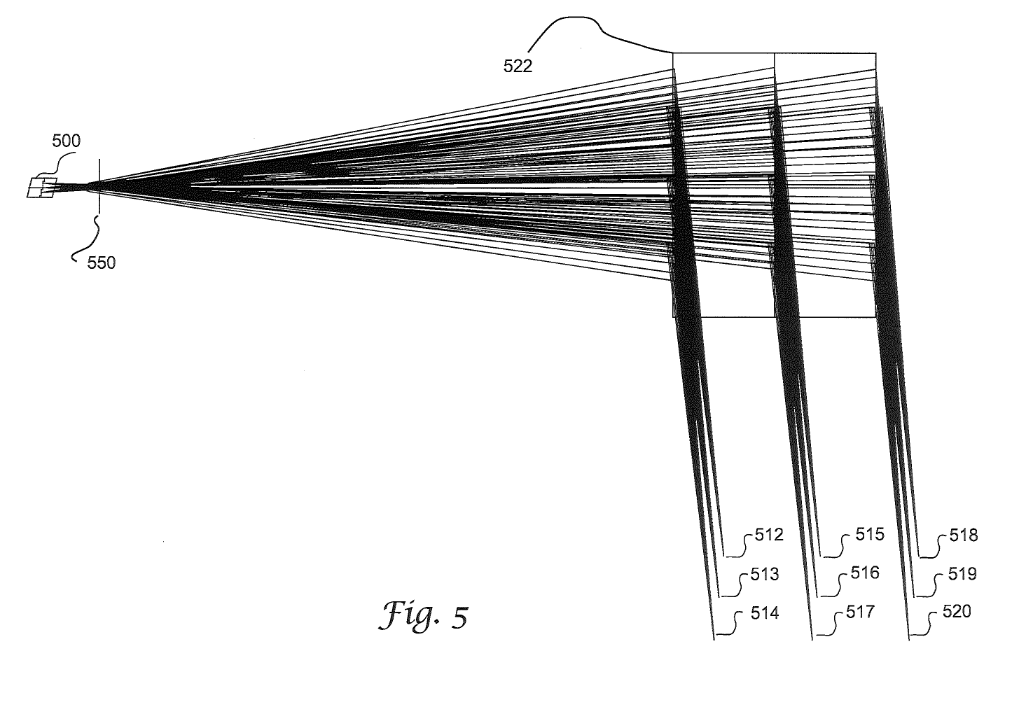

In FIG. 5 we see the identical diffraction range finder with the identical hologram as that of FIG. 3. The targets 512 through 520 are the same nine points with the same displacements and ranges as shown in FIG. 3. However, instead of a pinhole, slit 550 has been inserted where the pinhole was used in FIG. 3. It can be appreciated by comparing FIGS. 3 and 5 that the ray bundles in FIG. 5 are much broader in one of the two dimensions. This broadening of the ray bundles corresponds to an increase in the flux transmitted through the slit stop as compared with the paucity of flux that can be emitted from a pinhole. There are no attenuated rays denoted with dashed lines as there were in FIGS. 3 and 4(a), because all targets are visible at the image plane 500.

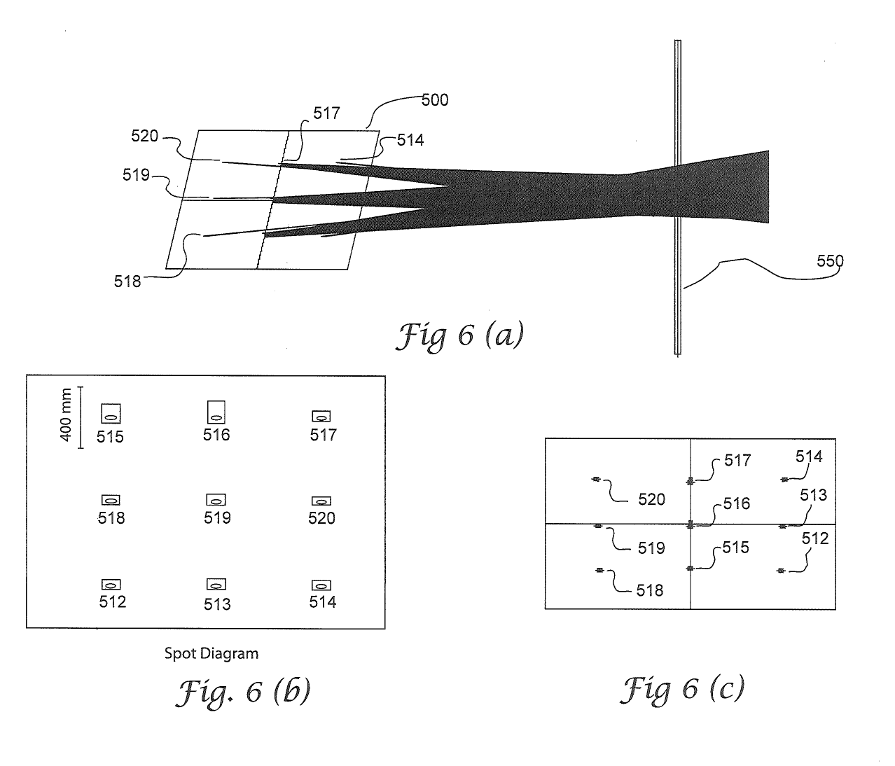

FIG. 6(a) shows a detail of FIG. 5 from the slit to the image plane. The density of rays at the image plane for all target points is an indicator of how much brighter the exemplary target points will be. The density of rays prohibits marking all rays in the illustration, but points 514, 518, and 520 are indicated. Solid ray bundles reach image plane 500 for these points and all target points.

FIG. 6(c) shows all target points appearing at the image plane. This can be compared with FIG. 4(c) where four of the nine targets were not visible.

Notably, when the spot diagrams of FIG. 4(b) from the pinhole and FIG. 6(b) from the slit are compared, the acuity or focus is nearly identical, notwithstanding that the distribution of energy in the spot diagram of FIG. 4(b) is elliptical and FIG. 6(b) is rectangular. This subtle difference between pinhole and slit apertures in the shape of a resolved point may have some numerical consequences in image processing but is far less of an impediment in forming an image than when flux is simply not available, as occurs for many targets imaged with a pinhole rather than a slit.

The improvement in flux collection of a slit over a pinhole in a diffraction range finder with a variable pitch grating has been measured by the inventor at 20 times the radiant flux.

The present invention has an advantage in the realization of a diffraction range finder with a variable pitch grating, because it will operate at lower light levels. There is always a limit to the amount of radiant energy available at a target. The use of a slit over a pinhole aperture is roughly the equivalent to having a four f-stop improvement in speed of a lens or an improvement from 64 to 1200 in the ISO number of a film. The improvement comes at no loss of acuity in the resulting image at the focal plane and without introducing any mechanical weakness in the imaging system. Use of a slit rather than a pinhole is unquestionably the default for the design of a variable pitch grating diffraction range finder as the art is now understood.

Diffraction range finders have many useful applications, and the present invention provides an improvement in performance with regard to sensitivity that allows diffraction range finders to be used where previously it was not practical. Notably in applications for microscopy where specimens absorb light especially when combined with limits on allowable radiation from lasers, the availability of a simple and effective improvement in sensitivity will have commercial benefits.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for forming a focused image on an image plane of a diffraction range finder with a variable pitch diffraction grating, said method comprising:
propagating diffracted light through a slit and onto an image plane of a camera, said diffracted light having been diffracted by the variable pitch diffraction grating.

2. A system for forming a focused image on an image plane of a diffraction range finder with a variable pitch diffraction grating, said system comprising:
the variable pitch diffraction grating; and
a slit through which diffracted light may traverse after having been diffracted by the diffraction grating, wherein the diffracted light is configured to form a focused image on an image plane of a camera after traversing the slit.
